(19) United States
(12) Patent Application Publication
(10) Pub. No.: US 2025/0292590 A1
(43) Pub. Date: Sep. 18, 2025

(54) METHOD AND APPARATUS FOR CONTEXT-RECOGNITION OBJECT ACTION PREDICTION AND PATH PLANNING FOR AUTONOMOUS VEHICLES BASED ON PEDESTRIAN MOTION PREDICTION

(71) Applicants: HYUNDAI MOTOR COMPANY, Seoul (KR); Kia Corporation, Seoul (KR)

(72) Inventor: Hye Rin LIM, Hwaseong-si (KR)

(73) Assignees: HYUNDAI MOTOR COMPANY, Seoul (KR); Kia Corporation, Seoul (KR)

(21) Appl. No.: 18/952,870

(22) Filed: Nov. 19, 2024

(30) Foreign Application Priority Data
Mar. 12, 2024 (KR) 10-2024-0034355

(51) Int. Cl. G06V 20/58; G06V 10/70; G06V 10/77; G06V 40/10; G06V 40/20

(52) U.S. Cl. CPC G06V 20/58; G06V 10/768; G06V 10/7715; G06V 40/10; G06V 40/20

(57) ABSTRACT

The present disclosure relates to a method and device for predicting object motion based on context recognition. Additionally, the present disclosure relates to a method for establishing a moving object path plan based on pedestrian motion prediction in a moving object capable of autonomous driving, using the method for predicting object motion based on context recognition. The method for predicting object motion based on context recognition, according to the present disclosure, includes generating a semantic map for context information associated with an object, generating a motion flow map that includes the motion flow for each object, generating a motion-semantic map based on the semantic and motion flow maps, and performing motion prediction of at least one object based on the motion-semantic map.

### CROSS REFERENCE TO RELATED APPLICATION

The present application claims the benefit of priority to Korean Patent Application No. KR10-2024-0034355, filed on Mar. 12, 2024 in the Korean Intellectual Property Office, the entire contents of which are incorporated herein for all purposes by this reference.

### BACKGROUND OF THE INVENTION

### Technical Field

The present disclosure relates to a method and device for predicting an object motion based on context recognition. In addition, the present disclosure relates to a method for establishing a moving object path plan based on pedestrian motion prediction of autonomous driving using the method for predicting an object motion based on context recognition.

### Description of the Related Art

In recent years, autonomous driving functions have increasingly been integrated into moving objects to enhance driving convenience. These functions are being developed with the goal of achieving fully autonomous driving, where the moving object can operate independently without any driver intervention, regardless of the situation. Achieving this level of autonomy requires a comprehensive understanding of the moving object's surroundings, including the detection and prediction of the movements of nearby objects and the moving object's own path.

In this context, within the field of image processing using artificial intelligence (AI), the term “object” refers to any distinguishable entity, whether a thing or a person, and is often called an “agent.” However, in a more specific sense, “object awareness” traditionally refers to identifying only things, excluding people. For individuals, the term “awareness of a person” is used separately. Nonetheless, for the purposes of this disclosure, “object” will be used to refer to both distinguishable things and people.

Various methods have been developed for object awareness and motion prediction. However, conventional techniques for predicting an object's motion typically rely solely on recognizing its past or current location and tracking changes in position using sensors (e.g., LiDAR, radar, etc.) to estimate the next location.

Conventional methods for encoding environmental information for object recognition include: 1) a polyline map encoding method, primarily used for vehicle path planning, which represents the start and end points of a lane; 2) a rasterized map encoding method, which encodes environmental information by depicting a semantic map in a grid format with a specified resolution; and 3) a vectorized map encoding method, which represents an object's motion through vectorization. Additionally, for predicting object motion, there is a vector coding method, which represents a motion vector for each individual object.

However, while conventional methods for object recognition are effective for their specific purposes, they face a significant issue: the data involved come from different domains, making it incompatible and difficult to process together. As a result, conventional object motion prediction methods struggle to incorporate context information along with each object's motion data, reducing both accuracy and efficiency. This challenge is even more significant when the target object is a pedestrian, as unpredictable behavior makes it difficult to accurately apply motion dynamics, further lowering prediction accuracy. In this context, the term “pedestrian” also includes cyclists.

In methods that predict a pedestrian's motion based on their location, sudden changes in speed and direction are difficult to anticipate. This issue could potentially be addressed by incorporating context, such as interactions between the pedestrian and their surroundings. However, no existing method has been validated for extracting this context, encoding it, and combining it with motion data to predict the path accurately. Therefore, further exploration is needed. In short, there is a need for a method that can integrate and use data from different domains without losing critical information. As a result, conventional methods for predicting a pedestrian's motion based on location struggle to accurately predict atypical behavior or sudden changes in speed and direction. Additionally, accurately forecasting the movements of nearby pedestrians becomes challenging for autonomous vehicles, making it difficult to plan a safe and effective path.

### SUMMARY

This disclosure is focused on providing a method and a device for accurately predicting an object's motion by combining context information and motion data from different domains. In addition, the present disclosure is technically directed to providing a method and device for establishing a safe path plan of a moving object capable of autonomous driving based on pedestrian motion prediction in the moving object using the method for predicting an object motion based on context recognition.

Additionally, this disclosure aims to provide a method and a device for creating a safe path plan for an autonomous moving object by predicting pedestrian motion using context-aware motion prediction. The technical problems solved by the present disclosure are not limited to those mentioned above and other technical problems which are not described herein will be clearly understood by a person having ordinary skill in the technical field, to which the present disclosure belongs, based on the following description.

A method for predicting object motion based on context recognition, according to an embodiment of the present disclosure, includes generating a semantic map that contains context information related to an object, creating a motion flow map that includes the motion flow of each object, combining these into a motion-semantic map, and then using this motion-semantic map to predict the motion of at least one object.

A method for creating a path plan for an autonomous moving object based on pedestrian motion prediction, according to another embodiment of the present disclosure, includes the following steps: generating a semantic map that contains context information related to the pedestrian, creating a motion flow map that illustrates the pedestrian's movement, combining the semantic map and motion flow map to produce a motion-semantic map, predicting the pedestrian's motion using this motion-semantic map, and establishing the vehicle's path plan based on the predicted pedestrian motion. In addition, the object may include a pedestrian.

Additionally, the context information may encompass details about the pedestrian's surrounding environment, their posture, or the interactions between the pedestrian and the environment.

Additionally, the motion flow map can represent motion data in a consistent dimension regardless of the object type by depicting the object's motion as a vector within each grid.

Additionally, to generate the motion-semantic map, the dimensions of the semantic map and the motion flow map may be aligned to be identical.

Furthermore, the motion-semantic map can be generated using a complex tensor with the same dimensions as the input.

According to another embodiment of the present disclosure, an object motion prediction device for autonomous driving incorporates context recognition. It includes a memory storing computer-readable instructions and at least one processor operated by these instructions. The instructions direct the at least one processor to generate a semantic map containing context information related to an object, create a motion flow map representing the motion flow for each object, and integrate these into a motion-semantic map. The device then uses this motion-semantic map to perform motion prediction for at least one object.

In addition, the object motion prediction device may further include at least one sensor, and the semantic map may consist of a plurality of semantic layers representing the object's surrounding environment based on a semantic segmentation and edge detection results derived from the sensor data.

In addition, the motion flow map may consist of a plurality of layers including motion information of each object. This is achieved by performing motion tracking using an object tracking algorithm for data obtained from the sensor and then performing vectorization for the motion-tracked data within each grid.

Additionally, a complex tensor with the same dimensions may be generated from the context information in the semantic map and the object motion information in the motion flow map. The motion-semantic map is then generated based on this complex tensor. The features briefly summarized above with respect to the present disclosure are merely exemplary aspects of the detailed description of the present disclosure that follows, and do not limit the scope of the present disclosure.

The present disclosure enables the fusion and utilization of information from different domains without any loss of data.

In accordance with the present disclosure, a more accurate prediction of an object's motion can be achieved by recognizing context information related to the object and incorporating this context into the behavior prediction process.

Furthermore, this disclosure enables more accurate pedestrian motion prediction by recognizing context information, such as the pedestrian's surrounding environment and posture, and incorporating this context into the behavior prediction process.

Additionally, in accordance with the present disclosure, an autonomous driving vehicle can travel on a safe path by detecting and responding to unexpected changes in pedestrian behavior in advance.

The effects derived from the present disclosure are not limited to those mentioned above. Other effects, not explicitly stated here, will become apparent to those skilled in the art upon reviewing the following descriptions.

### BRIEF DESCRIPTION OF THE DRAWINGS

FIG. 1 illustrates the concept of an autonomous driving vehicle that communicates by transmitting and receiving data with a neighboring device.

FIG. 2 is a view exemplifying a configuration of a moving object capable of autonomous driving according to an embodiment of the present disclosure.

FIG. 3 illustrates a detailed configuration for predicting an object motion in a moving object capable of autonomous driving and for establishing a path plan of the moving object in accordance with an embodiment of the present disclosure.

FIG. 4 illustrates an operation of a semantic map generator of a moving object capable of autonomous driving according to an embodiment of the present disclosure.

FIG. 5 illustrates an operation of a motion flow map generator of a moving object capable of autonomous driving according to an embodiment of the present disclosure.

FIG. 6 illustrates an operation of a motion-semantic map encoding unit of a moving object capable of autonomous driving according to an embodiment of the present disclosure.

FIG. 7 illustrates an example of object motion prediction generated by a motion prediction decoding unit of a moving object capable of autonomous driving according to an embodiment of the present disclosure.

FIG. 8 illustrates a method for predicting an object motion based on context recognition according to an embodiment of the present disclosure.

FIG. 9 illustrates a method for establishing a moving object path plan based on pedestrian motion prediction of a moving object capable of autonomous driving according to an embodiment of the present disclosure.

FIG. 10 is a view showing a detailed configuration of a moving object capable of autonomous driving according to an embodiment of the present disclosure.

FIG. 11 illustrates an example of a fusion result between a semantic map and a motion map according to an embodiment of the present disclosure.

### DETAILED DESCRIPTION OF THE INVENTION

Hereinafter, embodiments of the present disclosure will be described in detail with reference to the accompanying drawings. These embodiments can be readily implemented by those skilled in the art. However, it should be noted that the present disclosure is not limited to the specific embodiments described herein and may take various forms.

In the following description of the embodiments of the present disclosure, detailed explanations of well-known functions and configurations will be omitted if they risk obscuring the core aspects of the disclosure. Additionally, components unrelated to the description are excluded from the drawings, and similar parts are identified by corresponding reference numerals.

In the present disclosure, when a component is described as being ‘connected,’ ‘coupled,’ or ‘linked’ to another component, this can refer to both a direct connection and an indirect connection, where an intermediate component is present between them. Furthermore, when a component ‘includes’ or ‘has’ other components, it implies that additional components may be present unless the context explicitly indicates otherwise. In the present disclosure, terms such as “first” and “second” are used only for the purpose of distinguishing one component from other components, and do not limit the order, importance, or the like of components unless otherwise noted. Accordingly, within the scope of the present disclosure, a “first” component in an embodiment may be referred to as a “second” component in another embodiment, and similarly, a “second” component in an embodiment may also be referred to as a “first” component in another embodiment.

In the present disclosure, components that are distinguished from each other are intended to clearly describe each of their characteristics, and do not necessarily mean that the components are separated from each other. That is, a plurality of components may be integrated into one hardware or software unit, or one component may be distributed and configured in a plurality of hardware or software units. Therefore, even when not stated otherwise, such integrated or distributed embodiments are also included in the scope of the present disclosure.

In the present disclosure, components described in various embodiments do not necessarily mean essential components, and some may be optional components. Accordingly, an embodiment consisting of a subset of components described in an embodiment is also included in the scope of the present disclosure. In addition, embodiments containing other components in addition to the components described in the various embodiments are included in the scope of the present disclosure.

In the present disclosure, phrases such as “A or B”, “at least one of A and B”, “at least one of A or B”, “A, B or C”, “at least one of A, B and C”, and “at least one of A, B, C or a combination thereof” may each include any one of items listed therein or every possible combination of thereof.

The merits and characteristics of the present disclosure and a method of achieving the merits and characteristics will become more apparent from the embodiments described in detail in conjunction with the accompanying drawings. However, the present disclosure is not limited to the disclosed embodiments, but may be implemented in various different ways. The embodiments are provided to complete the present disclosure and to allow those skilled in the art to fully understand the scope of the disclosure.

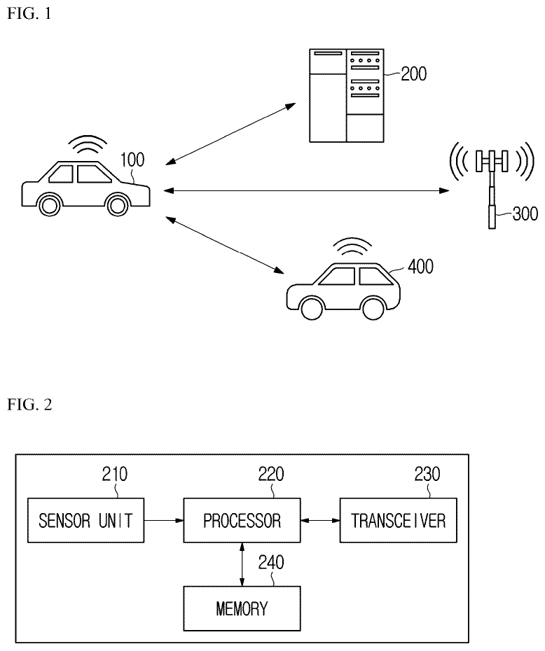

Hereinafter, referring to FIG. 1 the and FIG. 2, a conceptual relationship between a moving object and a neighbor device will be described in accordance with an embodiment of the present disclosure. First, FIG. 1 is a view exemplifying a concept of a moving object that transmits and receives data while communicating with another device.

The moving object 100 may refer to a device capable of moving. The moving object 100 is a ground moving object that is driven on the ground and may be a normal passenger vehicle or a commercial vehicle, a purpose built vehicle (PBV), and the like. In addition, the moving object 100 may be a four-wheel vehicle such as a sedan, a sports utility vehicle (SUV), or a pickup truck and may also be a moving object with five or more wheels such as a bus, a lorry, a moving object carrying a container, and a moving object carrying heavy equipment.

Meanwhile, the moving object 100 may perform communication with an external server 200, an external infrastructure device 300 or another moving object 400. For example, according to the present disclosure, the infrastructure device 300 may be an intelligent transportation system (ITS) device. However, this is merely an example, and the present disclosure is not limited to this. Accordingly, a CCTV installed on a road side may also be considered an infrastructure device according to the present disclosure.

For example, the server 200 may be an external device operated by a moving object manufacturer or provided for an autonomous driving service and may receive connected data of from the moving object 100 or transmit data necessary for autonomous driving. In order to support autonomous driving and various services for the moving object 100, the server 200 may transmit various types of information and software modules used for controlling the moving object 100 to it in response to a request and data transmitted from the moving object 100 and a user device. However, in the case that the moving object 100 itself is capable of processing information and a modules provided by the server 200 (e.g. ‘on-device AI function’), the moving object 100 may also generate and execute its own data needed for autonomous driving without communicating with the server 200.

As an example of the infrastructure device, the ITS device 300 may be a roadside unit (RSU). As the infrastructure device, the ITS device 300 may assist a user in driving their own car or support autonomous driving of the moving object 100 by exchanging vehicle recognition data, driving control and situation data, environmental data surrounding the moving object, and map data through V2I with the moving object 100.

In addition, through V2V with another moving object 400, the moving object 100 may support a driver's in driving their own car or assist with autonomous driving by exchanging the above-listed data. The moving object 100 may communicate with another moving object or another device based on cellular communication, wireless access in vehicular environment (WAVE) communication, dedicated short range communication (DSRC) or short range communication, or any other communication scheme.

FIG. 2 is a schematic diagram showing a configuration of a moving object 100 capable of autonomous driving according to an embodiment of the present disclosure. For example, a moving object according to the present disclosure may be implemented at least with a sensor unit 210, a processor 220 for performing an operation according to an embodiment of the present disclosure, a transceiver 230 for performing data transmission and reception to and from outside, and a memory 240 for storing instructions for executing the processor 220 and system data.

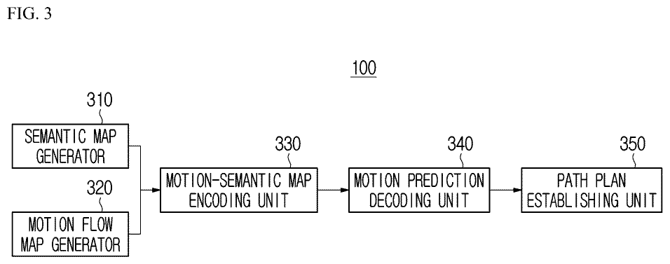

FIG. 3 illustrates a detailed configuration for predicting the motion of an object in a moving object capable of autonomous driving and for establishing a path plan of the moving object in accordance with an embodiment of the present disclosure. For example, the configuration of FIG. 3 may be implemented as a hardware module or a software module that is operated by the processor 220 of the moving object.

Referring to FIG. 3, a device for predicting an object motion according to an embodiment of the present disclosure includes a semantic map generator 310, a motion flow map generator 320, a motion-semantic map encoding unit 330, and a motion prediction decoding unit 340. In addition, a device for establishing a moving object path plan according to an embodiment of the present disclosure may further include a path plan establishing unit 350 in addition to the configuration of the device for predicting an object motion.

For example, a device for predicting an object motion according to an embodiment of the present disclosure generates a semantic map that includes context information associated with an object through the semantic map generator 310, generates a motion flow map that includes a motion flow of each object through the motion flow map generator 320, generates a motion-semantic map based on the semantic map and the motion flow map through the motion-semantic map encoding unit 330, and performs motion prediction of each object or at least of any one object based on the motion-semantic map through the motion prediction decoding unit 340. In addition, a device for establishing a moving object path plan according to an embodiment of the present disclosure establishes a path plan of a moving object based on a pedestrian motion that is predicted through the path plan establishing unit 350.

Hereinafter, an operation of each of the configurations will be described in detail with reference to FIG. 3 through FIG. 7.

First, the semantic map generator 310 constructs a semantic map by extracting context information around an object. Herein, the object may include a pedestrian located on a path where a moving object is operating, and the moving object may predict a next motion of the pedestrian and use the next motion for path planning. For example, by predicting that the pedestrian wants to cross the road, remains at the road side, or is likely to have an unexpected motion, driving control is performed to slow down the moving object, drive the moving object at a usual speed, or stop the moving object suddenly.

Herein, the context information may include information on the surrounding environment of the pedestrian. In addition, the context information may include information on a posture of the pedestrian. In addition, the context information may include information on the interaction between the surrounding environment and the pedestrian.

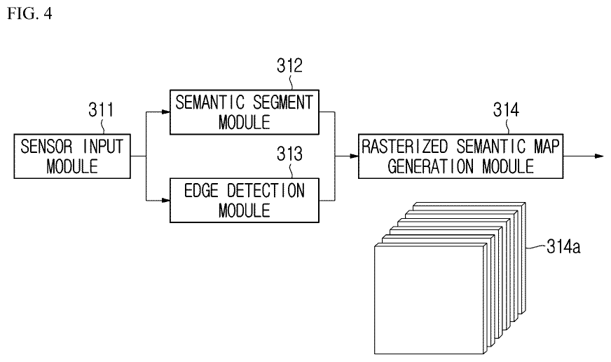

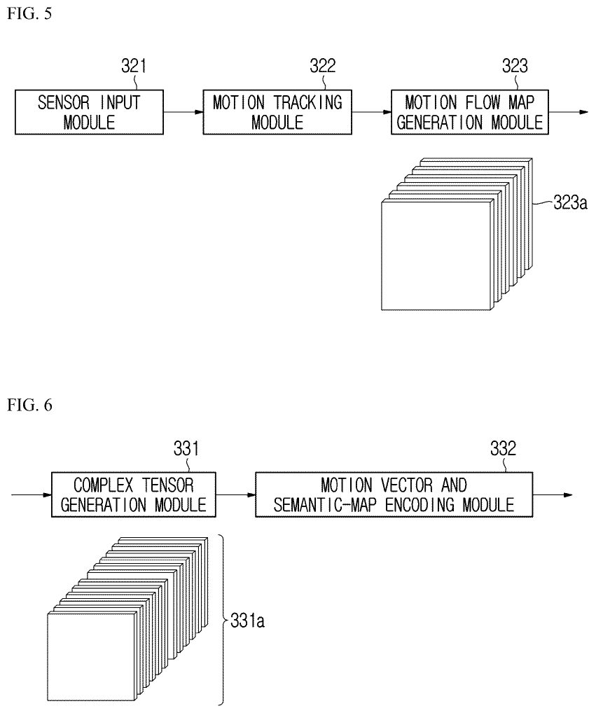

For example, FIG. 4 illustrates a detailed configuration of the semantic map generator 310 of the moving object capable of autonomous driving according to an embodiment of the present disclosure. For the convenience of explanation, FIG. 4 shows a configuration for performing each operation as a module, but this does not mean that such a module is physically distinguishable all the time. Accordingly, a functional module implemented by software may be included therein. For example, the configuration of FIG. 4 may be implemented as a hardware module or a software module that is operated by the processor 220 of the moving object. Likewise, this principle also applies to other modules illustrated in FIG. 5 and FIG. 6 of the present disclosure.

The semantic map generator 310 may consist of a sensor input module 311, a semantic segment module 312, an edge detection module 313, and a rasterized semantic map generation module 314.

Herein, the sensor input module 311 is a module that receives input data through the sensor 210 provided inside a moving object. For example, the moving object may obtain data about every object around it and its surrounding environment by using a high-resolution image sensor (e.g. camera, Lidar, IR camera).

The semantic segment module 312 recognizes context information including information on a surrounding environment associated with a pedestrian and/or information on the pedestrian's posture from data obtained from the sensor input module 311 and performs semantic segmentation of the context information. The semantic segmentation is also referred to as semantic feature extraction and means, especially in the AI image data processing field, a technique of segmenting objects groupable into the same class as a single object.

The edge detection module 313 detects edge information for distinguishing an object including a pedestrian from data obtained from the sensor input module 311.

In addition, the rasterized semantic map generation module 314 generates the semantic map based on context recognition. Specifically, the rasterized semantic map generation module 314 generates the semantic map consisting of a plurality of semantic layers 314a for the surrounding environment of the object based on the semantic segmentation result of the semantic segment module 312 and edge information of each object from the edge detection module 313.

In this regard, the plurality of semantic layers 314a, which constitute the semantic map, may include objects marked on the map (e.g. polyline, drive road, sidewalk, crosswalk, driving lane, stop line) and information according to a location that may affect the motion of a pedestrian. Generally, each of the semantic layers 314a may be represented by a bit map or probability.

Accordingly, the semantic map, which consists of the plurality of semantic layers 314a, includes, as context information, a segmentation result for an object including a pedestrian around a moving object and a road environment.

FIG. 5 illustrates a detailed configuration of the motion flow map generator 320 of the moving object capable of autonomous driving according to an embodiment of the present disclosure. For example, the configuration of FIG. 5 may be implemented as a hardware module or a software module that is operated by the processor 220 of the moving object. The motion flow map generator 320 may consist of a sensor input module 321, a motion tracking module 322, and a motion flow map generation module 323.

The sensor input module 321 may be configured to perform the same function as the sensor input module 311 in the above-described semantic map generator 310 of FIG. 4. Accordingly, the two sensor input modules 311 and 321 may be integrated into a single module in actual implementation. That is, the sensor input module 321 obtains data about every object around a moving object and its surrounding environment by using, for example, a high-resolution image sensor (e.g. camera, Lidar, IR camera) in the moving object.

The motion tracking module 322 performs a function of extracting a motion trajectory of each object from data obtained from the sensor input module 321 through an object tracking algorithm.

In addition, the motion flow map generation module 323 generates a motion flow map consisting of a plurality of layers 323a the include motion information of each object by performing vectorization on a result from the motion tracking module according to each grid cell. Here, the grid cell includes motion information of each object based on a motion tracking result of each object that is derived by the motion tracking module 322. For example, a location of each grid cell may mean a location of a corresponding object, and vectorized information in each grid cell indicates the speed, direction and acceleration of each object.

In addition, the plurality of layers 323a constituting the motion flow map may be provided for each object, and the number of layers increases according to the number of objects. Here, in the case that the object includes a pedestrian, a layer representing the motion flow of each pedestrian may be generated.

For example, as an example of representing the motion of an object by a vector in each grid, a grid cell with a pedestrian may have a vector representation with ‘magnitude (speed)=3 kph’ and ‘direction (object heading) of =30 degrees’, and a grid cell without pedestrian may have a vector representation with ‘magnitude=−1’ and ‘direction=−1 (e.g. default value)’.

FIG. 6 illustrates a detailed configuration of the motion-semantic map encoding unit 330 of a moving object capable of autonomous driving according to an embodiment of the present disclosure. For example, the configuration of FIG. 6 may be implemented as a hardware module or a software module that is operated by the processor 220 of the moving object. The motion-semantic map encoding unit 330 may consist of a complex tensor generation module 331 and a motion vector and semantic map encoding module 332.

In this regard, the tensor means an array of data, which may be distinguished into various dimensions (e.g. 3D tensor, 4D tensor, 5D tensor, etc.). That is, in the AI image data processing field, input data is distinguished by scalar, vector, matrix, or tensor, and herein, an upper data array may be configured to have a structure including a lower data array. For example, a matrix may be configured to include a plurality of vectors, and a tensor may be configured to include a plurality of matrices.

The complex tensor generation module 331 generates a complex tensor that is input into the motion vector and semantic map encoding module 332. For example, the complex tensor generation module 331 generates a complex tensor 331a constructed in the same dimension from context information of the semantic map and object motion information of the motion flow map. Herein, the same dimension may have the same resolution but different depths. For example, in order to integrate the context information and the object motion information, by applying a function such as CONCAT, ADD, AVERAGE or the like that is applicable to data operation in the same dimension, the complex tensor may be applied as an input tensor for the motion vector and semantic-map encoding module 332.

In this regard, because the motion flow map proposed by the present disclosure represents an object motion by a vector in each grid, motion data may be represented in the same dimension irrespective of an object type. That is, data fusion may be facilitated by bringing data dimensions into the same dimension.

That is, in the conventional case of fusing different types of information (e.g. map vs motion), the fusion is difficult to perform without missing information because of different data forms (e.g. map: image and motion: vector), and this results in the fundamental difficulty of high-level data fusion. On the other hand, a motion flow map according to the present disclosure brings object data and map data into the same dimension so that a data-fused tensor may be generated through a ‘concat’ operation that simply stacks layers. Consequently, a desired result may be derived through AI learning from the generated tensor.

That is, in the complex tensor generation module 331, because the fusion of a motion map and a semantic map is performed also in the same dimension, the fusion becomes possible through a simple operation such as layer ‘concat’, ‘add’ or ‘average’.

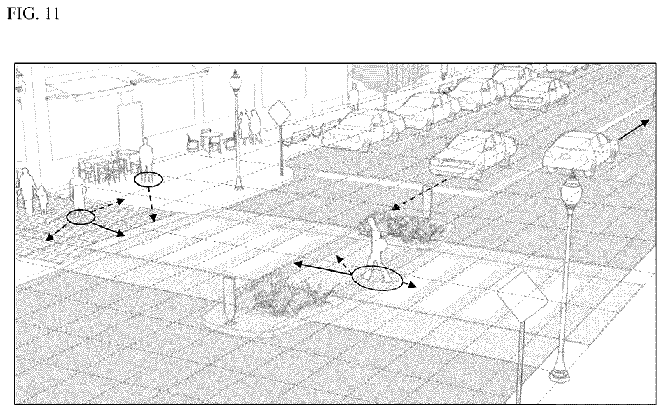

In this regard, FIG. 11 illustrates an example of a fusion result between a semantic map and a motion map according to the present disclosure. For example, it is shown that a grid of the semantic map and a grid of the motion flow map may be generated on a map by being matched through map matching using location information, map information, sensor information and similar data. Particularly, in the case that there is a pedestrian among objects marked on the map, information may be provided to enable the motion, posture and/or behavior change of the pedestrian to be predicted.

The motion vector and semantic-map encoding module 332 generates the motion-semantic map based on the input complex tensor. That is, the motion vector and semantic-map encoding module 332 may receive, as input, both a semantic feature and a motion feature of each object through the complex tensor.

Referring to FIG. 3 again, the motion prediction decoding unit 340 predicts a motion of each object or at least one object based on the motion-semantic map that is generated by the motion vector and semantic map encoding module 332. In addition, the path plan establishing unit 350 of FIG. 3 establishes a path plan of the moving object based on the predicted motion of a pedestrian.

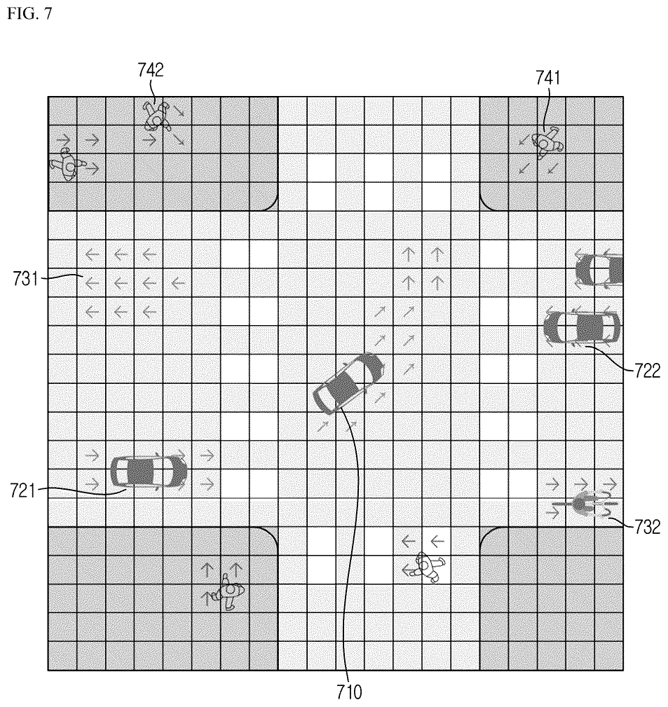

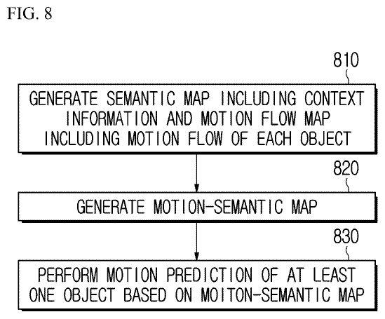

FIG. 7 illustrates an example of object motion prediction generated by the motion prediction decoding unit 340 in a moving object capable of autonomous driving according to an embodiment of the present disclosure. That is, based on an ego-vehicle moving object 710, neighboring objects may be recognized and their motions thereof may be predicted. For example, by decoding grid occupancy and vector information of the motion-semantic map, other vehicle moving objects 721 and 722 moving near the ego-vehicle moving object 710 may be recognized and their motion directions may be predicted. In addition, by decoding grid occupancy and vector information of the motion-semantic map, other objects 731 and 732 near the ego-vehicle moving object 710 may be recognized and their motions may be predicted. In addition, by decoding grid occupancy and vector information of the motion-semantic map, pedestrians 741 and 742 near the ego-vehicle moving object 710 may be recognized and the directions of their motions may be predicted. Particularly, as for the pedestrian 741 located near a road boundary, when predicting the motion of the pedestrian, it is possible to predict whether or not the pedestrian is going to cross a road where the ego-vehicle moving object 710 is moving or whether or not the pedestrian is likely to have an unexpected behavior.

FIG. 8 illustrates a method for predicting an object motion based on context recognition according to an embodiment of the present disclosure. First, the method for predicting an object motion based on context recognition according to an embodiment of the present disclosure may include generating a semantic map for context information associated with an object and a motion flow map that includes a motion flow for each object (810). In addition, the method for predicting an object motion based on context recognition according to an embodiment of the present disclosure may include generating a motion-semantic map based on the generated semantic map and motion flow map (820). In addition, the method for predicting an object motion based on context recognition according to an embodiment of the present disclosure may include performing motion prediction of at least one object based on the motion-semantic map (830).

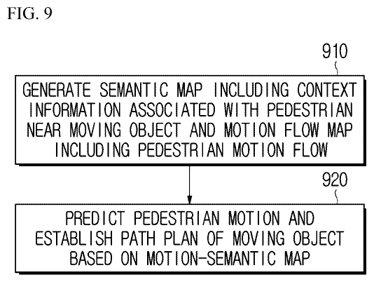

FIG. 9 illustrates a method for establishing a moving object path plan based on pedestrian motion prediction in a moving object capable of autonomous driving according to an embodiment of the present disclosure. First, the method for establishing a moving object path plan based on pedestrian motion prediction in a moving object capable of autonomous driving according to an embodiment of the present disclosure may include generating a semantic map that includes context information associated with a pedestrian and a motion flow map that includes a motion flow of the pedestrian respectively (910). In addition, the method for establishing a moving object path plan based on pedestrian motion prediction in a moving object capable of autonomous driving according to an embodiment of the present disclosure may include establishing a motion of the pedestrian and a path plan of the moving object based on a motion-semantic map (920).

Herein, the step S920 may further include generating the motion-semantic map based on the semantic map and the motion flow map, predicting the motion of the pedestrian based on the motion-semantic map, and establishing the path plan of the moving object based on the predicted motion of the pedestrian.

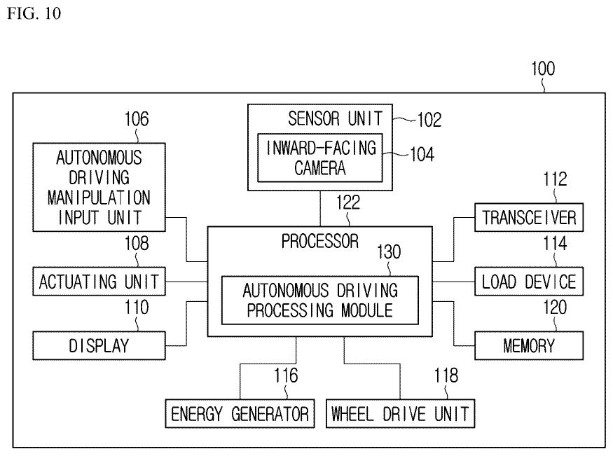

FIG. 10 illustrates an example of another detailed configuration of the moving object according to another embodiment of the present disclosure. Referring to FIG. 10, the moving object 100 may be driven based on electric energy or fossil energy. In the case of electric energy, for example, the moving object 100 may be a pure battery-based moving object driven only by a high-voltage battery or may employ a gas-based fuel cell as an energy source. In addition, the fuel cell may use various types of gas capable of generating electric energy, and for example, the gas may be hydrogen. However, without being limited to this, various gases may be applicable. In the case of fossil energy, the moving object 100 may be driven based on fuels such as gasoline, diesel, or liquefied gas, and may be equipped with an engine that drives a wheel drive unit 118 by the combustion of this fuel. The engine may be included in an energy generator 116 from a perspective of providing a driving torque of a wheel to the wheel drive unit 118.

For the convenience of explanation, the present disclosure describes the moving object 100 as an example of a moving object based on electric energy, but except for regenerative braking, charge, and discharge described in the present disclosure, an embodiment of the present disclosure may certainly be applicable to a moving object based on fossil energy.

The moving object 100 may be driven by being controlled through autonomous driving, and the autonomous driving may be implemented as semi-autonomous driving or full autonomous driving. Full autonomous driving may be provided as autonomous movement under the complete control of the processor 122 of the moving object 100 without a user's intervention even in an uncertain driving situation. Semi-autonomous driving may be provided as autonomous movement that requires a driver's intervention in a specific driving situation. When the driving situation occurs, semi-autonomous driving may be implemented such that the processor 122 disables autonomous driving and switches control to the user, and thus the user performs manual driving. According to the autonomous driving levels defined by the Society of Automotive Engineers (SAE), semi-autonomous driving may correspond to the autonomous driving levels 1 to 4. The autonomous driving level 2 supports the autonomous driving controller 142 of the moving object 100 to assist both steering and acceleration/deceleration, and as an example, the autonomous driving level 2 may be implemented to execute such functions as lane following assist (LFA), lane keeping assist (LKA), highway driving assist (HDA) and smart cruise control (SCC) and to disable the functions when switching to manual driving in a specific driving situation. The autonomous driving level 3 may support lane change and overtaking functions like the autonomous driving level 2 and switch control to a driver in case of a dangerous situation. The autonomous driving level 4 may be configured to control the entire moving object by the autonomous driving controller 142 in response to each unexpected situation, while not requiring a driver's forward-looking responsibility, and to switch the control only in significantly uncertain situation like bad weather.

Specifically, the moving object 100 may include at least a sensor unit 102, an autonomous driving manipulation input unit 106, an actuating unit 108, and a display 110. In this regard, the sensor unit 102 may provide the same function as the sensor unit 210 in FIG. 2.

The sensor unit 102 may be equipped with various types of detectors for sensing various states and situations that occur in the external and internal environments of the moving object 100. According to an embodiment of the present disclosure, the sensor unit 102 may be a sensor that provides sensor data to the sensor input modules 311 and 321 in FIG. 4 and FIG. 5. Specifically, the sensor unit 102 may be equipped with an outward-facing image sensor, a Lidar sensor, a radar sensor, and the like to perceive dynamic and static objects present outside the moving object 100. The sensor unit 102 may be equipped with a location sensor, a gyro sensor, an acceleration sensor, a wheel sensor, an odometer, a speed sensor, and the like to identify its own location, driving position, and speed. In addition, to monitor a user inside the moving object 100, a condition of an occupant, and an operating situation of an internal device of the moving object 100 that a user is capable of maneuvering, the sensor unit 102 may have an inward-facing camera 104, a biosensor for detecting biosignals of a driver and an occupant, and various detection modules for detecting the operation and state of an internal device. For example, the inward-facing camera 104 may be installed in a predetermined position inside the moving object or be built into the display 110. The camera 104 may capture motions of various body parts of a driver and a passenger and deliver the captured motions to the processor 122, and the processor 122, for example, a user monitoring unit, may estimate a user's physical condition through a motion of a body part. A physical condition may be the degree of fatigue of a driver and/or a passenger. In addition, a biosensor is provided as a contact-type sensor, which contacts a body part of a user to measure a biosignal, and may be configured in a pad form provided in a predetermined portion of, for example, a steering wheel and contacting a driver's hand or finger. For example, the biosensor may be configured to measure a user's pulse, blood pressure, and ECG as biosignals or to acquire biosignals such as blood pressure and ECG indirectly based on biosignals that are directly measured. Based on biosignals acquired from the biosensor, a user tendency analysis and monitoring unit may estimate a physical condition such as the user's fatigue.

The present disclosure mainly describes sensors of the sensor unit 102 referred to for description of an embodiment but may further include sensors for detecting various situations not listed herein.

In order to enable a user such as a driver to activate or deactivate an autonomous driving function provided in the moving object 100, the autonomous driving manipulation input unit 106 may be configured as an interface to use or release an autonomous driving mode requested from the user. For example, the autonomous driving manipulation input unit 106 may be implemented as a hard-type interface provided in a predetermined position in the moving object 100 or a soft-type interface that is touchable on the display 100. In the case of a hard-type interface, for example, the autonomous driving manipulation input unit 106 may be installed on a steering wheel, a dashboard, or the like. The autonomous driving manipulation input unit 106 may be configured as an interface that enables a user to select various functions provided at a corresponding level of autonomous driving. As another example, the autonomous driving manipulation input unit 106 may receive a user's input requesting activation of an autonomous driving mode, and the processor 122 may execute a function suitable for a driving situation among the functions of autonomous driving at a corresponding level, even if the user does not request any specific function. For example, at the autonomous driving level 2, an option key may be provided as an interface for a plurality of functions such as LFA, LKA, HDA, and SCC.

The actuating unit 108 may be equipped with at least one module for implementing a driving operation and perform at least one driving operation of longitudinal control like acceleration/deceleration and transverse control like steering. The actuating unit 108 may be equipped with not only a pedal and a steering wheel for accepting a user's request for the control but also various operating modules for generating a driving operation according to the request from the wheel drive unit 118.

The display 110 may serve as a user interface. Through the processor 122, the display 110 may display an operating state and a control state of the moving object 100, path/traffic information, information on the remaining energy quantity, a content requested by a driver, and the like to be output. The display 110 may be configured as a touch screen capable of sensing a driver input and may receive a request of a driver communicated to the processor 122.

Meanwhile, the moving object 100 may include a transceiver 112, a load device 114, the energy generator 116, and the wheel drive unit 118.

For example, the transceiver 112 may support mutual communication with the server 200, the ITS device 300, and the neighboring moving object 400, which are described in FIG. 1. In the present disclosure, the transceiver 112 may transmit data generated or stored during driving to the server 200 and receive data and a software module transmitted from the server 200. In the present disclosure, the moving object 100 may transmit and receive data used in a method according to the present disclosure to and from the outside through the transceiver 112.

The load device 114 may be an auxiliary equipment mounted on the moving object 100, which consumes power supplied from the energy generator 116 by use of an occupant or user or power converted from the output of the energy generator 116. The load device 114 may be a type of electric device for non-driving purpose excluding a driving power system like the wheel drive unit 118 in the present disclosure. For example, the load device 114 may be various devices installed in an air-conditioning system, a lighting system, a seat system and other parts of the moving object 100.

The energy generator 116 may generate and supply power and electricity used for a driving power system like the wheel drive unit 118 and the load device 114. In the case that the moving object 100 is driven based on electric energy, for example, the energy generator 116 may be configured as an electric battery or as a combination of an electric battery and a fuel cell for charging the battery. When using a combination of an electric battery and a fuel cell, the energy generator 116 may include a tank for storing a material used to produce power of the fuel cell, for example, hydrogen gas. If the moving object 100 is driven based on fossil energy, the energy generator 116 may be configured as an internal combustion engine.

The wheel drive unit 118 may include a plurality of wheels, a driving force transfer module for generating and giving a driving force to the wheels or for transferring a driving force, a braking module for decelerating the driving of the wheels, and a steering module for realizing transverse control of the wheels. If the moving object 100 is driven based on electric energy, the driving force transfer module may be configured as a motor module that generates a driving force based on power output from an electric battery. If the moving object 100 is operated based on fossil energy, a driving force transfer module may be equipped with a transmission and a gear module that transfer power from an internal combustion engine.

In addition, the moving object 100 may include a memory 120 and the processor 122. The memory 120 may store an application for controlling the moving object 100 and various data and may load the application or read and record data at the request of the processor 122. In the present disclosure, the memory 120 may store an application and at least one instruction for recognizing an object (including a pedestrian) on a driving path of the moving object 100 controlled in an autonomous driving mode and/or predicting its motion and using that motion in establishing a path plan of the moving object.

To this end, for example, the memory 120 may store and manage driving history information of a user (or driver) of the moving object 100, map information, and the like. The map information stored in the memory 120 may be used to create a driving path set for the moving object 100 at a request of a user or the processor 122. In addition, the map information may be used for autonomous driving and may include a low definition map or include an HD map together with the map. The map information may be provided to include various information and data included in the driving environment information.

The processor 122 may perform overall control of the moving object 100. The processor 122 may be configured to execute an application and an instruction stored in the memory 120. In relation to the present disclosure, the processor 122 is capable of performing the above-described operations of FIG. 3 to FIG. 9.

The various embodiments of the present disclosure are not intended to list all possible combinations but to illustrate representative aspects of the present disclosure. The matters described in the various embodiments may be applied independently or in a combination of two or more.

Also, the various embodiments of the present disclosure may be implemented by hardware, firmware, software, or a combination thereof. For hardware implementation, the embodiment may be implemented by using at least one or more of a group of application specific integrated circuits (ASICs), digital signal processors (DSPs), digital signal processing devices (DSPDs), programmable logic devices (PLDs), field programmable gate arrays (FPGAs), general-purpose processors, controllers, micro controllers, and micro processors.

The scope of the present disclosure includes software or machine-executable instructions (for example, an operating system, an application, firmware, a program, etc.), which cause an operation according to the methods of the various embodiments to be performed on a device or a computer, and includes a non-transitory computer-readable medium storing such software or instructions to be executed on a device or a computer.

What is claimed is:

1. A method for predicting an object motion based on context recognition in a moving object capable of autonomous driving, the method comprising:
generating, by at least one processor, a semantic map for context information associated with an object and a motion flow map including a motion flow according to each object;
generating, by the at least one processor, a motion-semantic map based on the semantic map and the motion flow map; and
performing, by the at least one processor, motion prediction of at least one object based on the motion-semantic map.

2. The method of claim 1, wherein the object includes at least one of a pedestrian.

3. The method of claim 2, wherein the context information includes information on a surrounding environment of the pedestrian.

4. The method of claim 2, wherein the context information includes information on a posture of the pedestrian.

5. The method of claim 2, wherein the context information includes information on interaction between a surrounding environment of the pedestrian and the pedestrian.

6. The method of claim 1, wherein the motion flow map represents motion data in a same dimension regardless of a type of an object by representing an object motion as a vector in each grid.

7. The method of claim 1, wherein, generating the motion-semantic map comprises aligning a dimension of the semantic map and a dimension of the motion flow map to be identical.

8. The method of claim 7, wherein the motion-semantic map is generated by a complex tensor with a same dimension as input.

9. An object motion prediction device for performing object motion prediction based on context recognition in a moving object capable of autonomous driving, the object motion prediction device comprising:
a memory configured to store a computer-readable instruction; and
at least one processor configured to execute the instruction, wherein the instruction causes the at least one processor to:
generate a semantic map for context information associated with an object and a motion flow map including a motion flow according to each object,
generate a motion-semantic map based on the semantic map and the motion flow map, and
perform motion prediction of at least one object based on the motion-semantic map.

10. The object motion prediction device of claim 9, further comprising a sensor,
wherein the semantic map consists of a plurality of semantic layers for a surrounding environment of an object based on a semantic segment and an edge detection results from data obtained from the sensor.

11. The object motion prediction device of claim 10, wherein the motion flow map consists of a plurality of layers including motion information of each object by performing motion tracking through an object tracking algorithm for the data obtained from the sensor and performing vectorization for motion-tracked data in each grid.

12. The object motion prediction device of claim 11, wherein a complex tensor configured in a same dimension is generated from the context information of the semantic map and object motion information of the motion flow map, and the motion-semantic map is generated based on the complex tensor.

13. A method for establishing a moving object path plan based on pedestrian motion prediction in a moving object capable of autonomous driving, the method comprising:
generating, by at least one processor, a semantic map that includes context information associated with a pedestrian and a motion flow map that includes a motion flow of the pedestrian;
generating, by the at least one processor, a motion-semantic map based on the semantic map and the motion flow map;
predicting, by the at least one processor, a motion of the pedestrian based on the motion-semantic map; and
establishing, by the at least one processor, a path plan of the moving object based on the predicted motion of the pedestrian to control autonomous driving of the moving object.

14. The method of claim 13, wherein the object includes a pedestrian.

15. The method of claim 14, wherein the context information includes information on a surrounding environment of the pedestrian.

16. The method of claim 14, wherein the context information includes information on a posture of the pedestrian.

17. The method of claim 14, wherein the context information includes information on interaction between a surrounding environment of the pedestrian and the pedestrian.

18. The method of claim 13, wherein the motion flow map represents motion data in a same dimension regardless of a type of an object by representing an object motion as a vector in each grid.

19. The method of claim 13, wherein, generating the motion-semantic map, comprises aligning a dimension of the semantic map and a dimension of the motion flow map to be identical.

20. The method of claim 19, wherein the motion-semantic map is generated using a complex tensor having a same dimension as input.
